(19) United States
(12) Patent Application Publication
(10) Pub. No.: US 2012/0243085 A1
(43) Pub. Date: Sep. 27, 2012

(54) THREE DIMENSIONAL DISPLAY DEVICE AND THREE DIMENSIONAL DISPLAY SYSTEM

(75) Inventors: Yang SUN, Beijing (CN); Yinglong HUANG, Beijing (CN); Jing LV, Beijing (CN)

(73) Assignee: BOE TECHNOLOGY GROUP CO., LTD., Beijing (CN)

(21) Appl. No.: 13/424,688

(22) Filed: Mar. 20, 2012

(30) Foreign Application Priority Data
Mar. 22, 2011 (CN) 201120076793.7

(51) Int. Cl. G02B 27/26; G02B 27/22

(52) U.S. Cl. 359/465; 359/462

(57) ABSTRACT

Embodiments of the disclosed technology provide a three dimensional (3D) display device, comprising: an optical lens group, display panels, and a display plane, wherein the display panels comprises a first display panel and a second display panel for emitting image light with different polarization states, and wherein the optical lens group is used to refract polarized light emitted from the first and second display panels onto the display plane, so that the image light emitted from the first and second display panels forms images on the display plane. In addition, a 3D display system comprising the above 3D display device is also provided.

### BACKGROUND

Embodiments of the disclosed technology relate to a three dimensional (3D) display device and a 3D display system.

As for 3D display technology, some types are based on a similar principle, i.e., receiving different images through the right eye and the left eye of a viewer, superposing the image information by the human brain to reproduce a 3D image and generate a stereoscopic effect with a sense of direction such as front-back, up-down, left-right, far-near and the like.

The current 3D display technologies need to provide different images for the left eye and the right eye of a viewer, respectively. In order to provide images with a refresh frequency of no less than 60 Hz for the two eyes, the refresh frequency of the display panel need be increased up to more than 120 Hz, which exerts a strict demand on the refresh frequency of the display panel. Otherwise, if the refresh frequency of the display panel can not be increased, then a general countermeasure to realize a 3D displaying is making light emitted by one half of pixels in the display panel enter into the left eye and light by the other half enter into the right eye. However, in such a displaying manner, the resolution of a single display panel will be decreased by a half and the 3D displaying performance is deteriorated.

### SUMMARY

An embodiment of the disclosed technology provides a three dimensional (3D) display device, comprising: an optical lens group, display panels, and a display plane, wherein the display panels comprises a first display panel and a second display panel, image light emitted from the first display panel is polarized light with a first polarization state, and image light emitted from the second display panel is polarized light with a second polarization state, and the first polarization state is different from the second polarization state, and wherein the optical lens group is provided at the display surface side of the display panels to refract polarized light emitted from the first and second display panels onto the display plane, so that the image light emitted from the first and second display panels forms images on the display plane, and image light of each pixel on the display plane is composed of the image light from a corresponding pixel on the first display panel and a corresponding pixel on the second display panel.

Another embodiment of the disclosed technology provides a three dimensional (3D) display system, comprising: a 3D display device and a set of polarizing glasses, wherein the set of polarizing glasses comprises a left polarizing lens, a right polarizing lens, and a glass frame supporting the left and right polarizing lenses, wherein the 3D display device comprises an optical lens group, display panels, and a display plane, wherein the display panels comprises a first display panel and a second display panel, image light emitted from the first display panel is polarized light with a first polarization state, and image light emitted from the second display panel is polarized light with a second polarization state, and the first polarization state is different from the second polarization state, wherein the optical lens group is provided at the display surface side of the display panels to refract polarized light emitted from the first and second display panels onto the display plane, so that the image light emitted from the first and second display panels forms images on the display plane, and image light of each pixel on the display plane is composed of the image light from a corresponding pixel on the first display panel and a corresponding pixel on the second display panel, and wherein the left polarizing lens and the right polarizing lens are used to respectively receive the polarized light with the two different polarization states, which is emitted from the first and second display panels and projected on the display plane.

Further scope of applicability of the disclosed technology will become apparent from the detailed description given hereinafter. However, it should be understood that the detailed description and specific examples, while indicating preferred embodiments of the disclosed technology, are given by way of illustration only, since various changes and modifications within the spirit and scope of the disclosed technology will become apparent to those skilled in the art from the following detailed description.

### BRIEF DESCRIPTION OF THE DRAWINGS

The disclosed technology will become more fully understood from the detailed description given hereinafter and the accompanying drawings which are given by way of illustration only, and thus are not limitative of the disclosed technology and wherein:

FIG. 1 is a structural schematic view of a 3D display device according to an embodiment of the disclosed technology; and

FIG. 2 is a structural schematic view of a 3D display system according to an embodiment of the disclosed technology.

### DETAILED DESCRIPTION

Embodiments of the disclosed technology now will be described more clearly and fully hereinafter with reference to the accompanying drawings, in which the embodiments of the disclosed technology are shown. Apparently, only some embodiments of the disclosed technology, but not all of embodiments, are set forth here, and the disclosed technology may be embodied in other forms. All of other embodiments made by those skilled in the art based on embodiments disclosed herein without mental work fall within the scope of the disclosed technology.

### First Embodiment

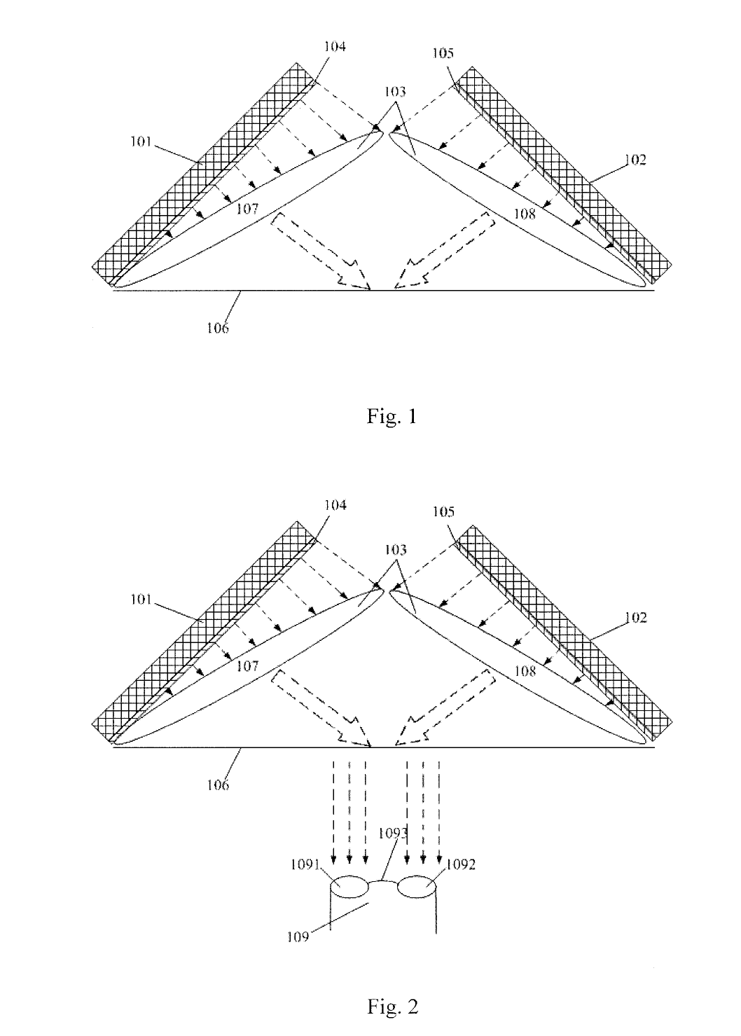

As shown in FIG. 1, a 3D display device according to an embodiment of the disclosed technology comprises two display panels 101 and 102 and an optical lens group 103. The light emitted from the two display panels is irradiated onto a display plane 106, and specifically is refracted by the optical lens group to reach the display plane 106. The display panels 101 can emit image light with a first polarization state, and the display panel 102 can emit image light with a second polarization state which is different from the first polarization state.

The two display panels 101 and 102 are provided symmetrically with an angle therebetween so that their display surfaces face each other; but the disclosed technology is not limited to this configuration. In one example, the angle between the two display panels is an obtuse angle, and the two display panels are provided at an equal angle with respect to the display plane 106. The two display panels 101 and 102 may comprise a first polarizing sheet 104 and a second polarizing sheet 105 which are respectively used to make the image light emitted from the display panel 101 and the image light emitted from the display panel 102 have different polarization states. The first polarizing sheet 104 is provided on the displaying surface side of the display panel 101, the second polarizing sheet 105 is provided on the displaying surface side of the display panel 102, and the optical lens group 103 is provided in front of the first and second polarizing sheets 104 and 105. The optical lens group 103 is used to refract the polarized light emitted from the display panels 101 and 102 to the display plane 106 and to form images on the display plane 106. The display plane 106 may be a projection screen of an appropriate type, for example, a glass screen.

The polarization directions of the first and second polarizing sheets 104 and 105 are perpendicular to each other. For example, the polarization direction of the first polarizing sheet 104 is horizontal, and the polarization direction of the second polarizing sheet 105 is vertical. Alternatively, the polarization direction of the first polarizing sheet 104 is vertical, and the polarization direction of the second polarizing sheet 105 is horizontal. However, the disclosed technology is not limited to the vertical and horizontal polarization directions, and the same effect can be obtained as long as the two polarization directions are perpendicular to each other. Further, the polarization states of the image light from the two display panels 101 and 102 are not limited to the linear polarization states as mentioned above, and the image light from the two image display panels 101 and 102 may be circularly polarized light with opposite rotation directions.

In addition, the means for making the image light from the two display panels have different polarization states is not limited to the polarization sheets provided at the display surface sides of the display panels, and any other suitable methods can be employed.

In one example, as shown in FIG. 1, the optical lens group 103 in the 3D display device provided by the embodiment of the disclosed technology comprises two optical lenses 107 and 108. The optical lens 107 is provided in front of the first polarizing sheet 104 of the display panel 101, the optical lens 108 is provided in front of the second polarizing sheet 105 of the display panel 102, and the optical lens 107 and the optical lens 108 are provided symmetrically with respect to the central line of the whole 3D display device.

Each of the optical lens 107 and the optical lens 108 has an angle with respect to the display plane 106, and the size of the angle depends on the optical characteristic of the lens. The size of the angle is set so that the polarized light emitted from the two display panels 101 and 102 can be refracted by the optical lenses 107 and 108 onto the display plane 106 to form images for 3D displaying. In addition, in order to display a 3D image, the image light of each pixel on the display plane is composed of the light emitted by corresponding pixels in each of the two display panels 101 and 102 (i.e., one corresponding pixel in one of the two display panels and one corresponding pixel in the other display panel). In addition, the images formed by the light from the two display panels 101 and 102 correspond to each other so as to form composite images for the right and left eyes.

In one example, the first polarizing sheet 104 is attached on the display surface of the display panel 101, and the second polarizing sheet 105 is attached on the displaying surface of the display panel 102.

### Second Embodiment

Another embodiment of the disclosed technology provides a three dimensional (3D) display system. The 3D display system comprises the 3D display device according to the embodiment of the disclosed technology and a set of polarizing glasses 109.

The polarizing glasses 109 comprises two polarizing lenses, i.e., the left polarizing lens 1091 and the right polarizing lens 1092, and a glass frame 1093 used to support the left and right polarizing lenses 1091 and 1092. The left and right polarizing lenses 1091 and 1092 are used to respectively receive the polarized light with two different polarization states emitted from the two display panels 101 and 102 and projected onto the display plane by the refraction of the optical lens group 103. For example, the two different polarization states are two perpendicular directions of linear polarization or two opposite rotation directions of circular polarization.

In one example, in the 3D display device of the 3D display system, the optical lens group 103 comprises a pair of optical lenses 107 and 108 which are symmetrically provided in front of the first and second polarizing sheets 104 and 105.

Specifically, the left polarizing lens 1091 receives the polarized light emitted by the display panel 101 on the left side in the drawing and refracted by the optical lens 107; and the right polarizing lens 1092 receives the polarized light emitted by the display panel 102 on the right side in the drawing and refracted by the optical lens 108. The polarized light with two different polarization states enters into the left and right eyes, respectively, and the 3D image is formed by a synthesis process in the human brain.

Further, in the 3D display system provided by the embodiment of the disclosed technology, each of the optical lenses 107 and 108 is provided at an angle with respect to the display plane, and the size of the angle is determined according to the similar principle of the above 3D display device, which will not be repeated herein.

In the 3D display system provided by the embodiment of the disclosed technology, the first and second polarizing sheets 104 and 105 are attached on the display surfaces of the two display panels 101 and 102, respectively.

The other characteristics of the 3D display device in the 3D display system are the same to those for the 3D display device as described in the first embodiment, which is not repeated here.

In the 3D display device and the 3D display system according to the embodiments of the disclosed technology, two display panels are provided to emit image light of different polarization states. Further, the optical lens group is used to refract the polarized light emitted by the two display panels onto the display plane for forming images for 3D displaying. Thus, even if the refresh frequency of the single display panel is not increased, 3D image with refresh frequency of no less than 60 Hz can be provided for the two eyes of the viewer, which decreases the hardware requirements on the display panel. In addition, the image light of each pixel on the final display plane is composed of the polarized light emitted by the two display panels; therefore, the resolution is not decreased and the 3D displaying performance is ensured.

The exemplary embodiments of the disclosed technology are described as above, however, the disclosed technology is not limited to these specific examples. The display panels comprise but not limited to liquid crystal display (LCD) panels, organic light emitting diode (OLED) display panels and plasma display panels (PDP).

It should be noted that the above embodiments only have the purpose of illustrating the disclosed technology, but not limiting it. Although the disclosed technology has been described with reference to the above embodiment, those skilled in the art should understand that modifications or alternations can be made to the solution or the technical feature in the described embodiments without departing from the spirit and scope of the disclosed technology.

What is claimed is:

1. A three dimensional (3D) display device, comprising:
an optical lens group,
display panels, and
a display plane,
wherein the display panels comprises a first display panel and a second display panel, image light emitted from the first display panel is polarized light with a first polarization state, and image light emitted from the second display panel is polarized light with a second polarization state, and the first polarization state is different from the second polarization state, and
wherein the optical lens group is provided at the display surface side of the display panels to refract polarized light emitted from the first and second display panels onto the display plane, so that the image light emitted from the first and second display panels forms images on the display plane, and image light of each pixel on the display plane is composed of the image light from a corresponding pixel on the first display panel and a corresponding pixel on the second display panel.

2. The device of claim 1, wherein the image light emitted from the first and second display panel is linearly polarized light, and a polarization direction of the first polarization state is perpendicular to that of the second polarization state.

3. The device of claim 1, wherein the image light emitted from the first and second display panel is circularly polarized light, and a rotation direction of the first polarization state is opposite to that of the second polarization state.

4. The device of claim 1, wherein the display panels comprises a first polarizing sheet and a second polarizing sheet which are provided at the display surface sides of the first and second display panels, respectively, so that the image light from the first and second display panels has the first and second polarization states.

5. The device of claim 1, wherein the first and second display panels are provided with an angle therebetween to allow their respective display surfaces face each other.

6. The device of claim 1, wherein the optical lens group comprises a pair of optical lenses which are provided at the display surface sides of the first display panel and the second display panel, respectively.

7. The device of claim 6, wherein each optical lens in the pair of the optical lenses is provided with an angle with respect to the display plane so that the image light emitted from each display panel forms images on the display plane.

8. The device of claim 4, wherein the first polarizing sheet and the second polarizing sheet are attached on the display surface sides of the first and second display panels, respectively.

9. The device of claim 5, wherein the angle between the first and second display panels is an obtuse angle.

10. The device of claim 5, wherein the first and second display panels are provided symmetrically, and an angle between the first display panel and the display plane is the same as that between the second display panel and the display plane.

11. The device of claim 1, wherein the display panels are liquid crystal display panels, organic light emitting diode (OLED) display panels or plasma display panels.

12. A three dimensional (3D) display system, comprising:
a 3D display device and a set of polarizing glasses,
wherein the set of polarizing glasses comprises a left polarizing lens, a right polarizing lens, and a glass frame supporting the left and right polarizing lenses,
wherein the 3D display device comprises:
an optical lens group,
display panels, and
a display plane,
wherein the display panels comprises a first display panel and a second display panel, image light emitted from the first display panel is polarized light with a first polarization state, and image light emitted from the second display panel is polarized light with a second polarization state, and the first polarization state is different from the second polarization state, and
wherein the optical lens group is provided at the display surface side of the display panels to refract polarized light emitted from the first and second display panels onto the display plane, so that the image light emitted from the first and second display panels forms images on the display plane, and image light of each pixel on the display plane is composed of the image light from a corresponding pixel on the first display panel and a corresponding pixel on the second display panel, and
wherein the left polarizing lens and the right polarizing lens are used to respectively receive the polarized light with the two different polarization states, which is emitted from the first and second display panels and projected on the display plane.

13. The system of claim 12, wherein the image light emitted from the first and second display panel is linearly polarized light, and a polarization direction of the first polarization state is perpendicular to that of the second polarization state.

14. The system of claim 12, wherein the image light emitted from the first and second display panel is circularly polarized light, and a rotation direction of the first polarization state is opposite to that of the second polarization state.

15. The system of claim 12, wherein the display panels comprises a first polarizing sheet and a second polarizing sheet which are provided at the display surface sides of the first and second display panels, respectively, so that the image light from the first and second display panels has the first and second polarization states.

16. The system of claim 12, wherein the first and second display panels are provided with an angle therebetween to allow their respective display surfaces face each other.

17. The system of claim 12, wherein the optical lens group comprises a pair of optical lenses which are provided on the display surface sides of the first display panel and the second display panel, respectively.

18. The system of claim 17, wherein each optical lens in the pair of the optical lenses is provided with an angle with respect to the display plane so that the image light emitted from each display panel forms images on the display plane.

19. The system of claim 16, wherein the angle between the first and second display panels is an obtuse angle.

20. The system of claim 12, wherein the display panels are liquid crystal display panels, organic light emitting diode (OLED) display panels or plasma display panels.
